(19) United States
(12) Patent Application Publication
(10) Pub. No.: US 2017/0185735 A1
(43) Pub. Date: Jun. 29, 2017

(54) ANALYZING DOCTOR-DOCTOR, PATIENT-DOCTOR, AND PATIENT-PATIENT SOCIAL NETWORKS

(71) Applicant: International Business Machines Corporation, Armonk, NY (US)

(72) Inventors: Ana P. Appel, Sao Paulo (BR); Marcia Ito, Sao Paulo (BR); Luis G. Moyano, Rio de Janeiro (BR); Vagner F. Santana, Sao Paulo (BR)

(21) Appl. No.: 14/982,292

(22) Filed: Dec. 29, 2015

(51) Int. Cl. G06F 19/00; G06Q 50/22; G06Q 50/00

(52) U.S. Cl. CPC G06F 19/3418; G06Q 50/01; G06Q 50/22

(57) ABSTRACT

Aspects of the present invention include a method, system and computer program product for utilizing transactional type health care data within various types of relationships or social networks (e.g., doctor-patient) in the health care industry and for determining various patterns of data therefrom to support improved decision making based on the determined data patterns.

### BACKGROUND

The present invention relates to social networks, and more specifically, to a method, system and computer program product that utilizes transactional type health care data within various types of relationships or social networks (e.g., doctor-patient) in the health care industry and determines various patterns of data therefrom to support improved decision making based on the determined data patterns.

Medical data inherently generated, stored e.g., in a cloud, and utilized in health care organizations is mostly transactional type data and includes data regarding, for example, doctor-patient consultations (e.g., diagnostic and treatment advice given by doctors to patients), patient claims filed and processed by health insurers, prescriptions written by doctors and filled by pharmacies, exams (e.g., X-Rays, Mills) provided by doctors and third parties, and other similar type events that routinely occur in the health care industry.

More specifically, current health care insurance business intelligence practices focus mainly on aspects of individuals or groups of individuals of the same type. For example, a certain business intelligence process may analyze a particular type of physician or physicians (e.g., general practice providers, orthopedic surgeons, etc.) and provide statistics on that professional or professionals, median of number of patients, total amount charged to the health insurance company, etc.

This approach is limited because the ecosystem formed by physicians, patients, and other stakeholders in the health care industry importantly includes the relationships among its elements. For instance, a relatively strong connection, relationship or link between a patient and a doctor most often is not taken into consideration, but should be taken into consideration, as this link may have a relatively strong economic impact to the health care insurance company, and it possibly goes undetected by current state-of-the-art business intelligence practices. As such, current business intelligence techniques only yield at best a partial view of important aspects of issues that are important to the health care industry.

Thus, transactional type data is somewhat limited in its ability to support various analyses of the data based on different relationships or social networks within the health care industry, such as doctor-patient, doctor-doctor, and even patient-patient. Such data is also limited in its ability to allow for someone to extract or find relatively complex patterns that are present within the underlying data. This is not only the case for data related to health care organizations but is also true for the inherent data within other service type industries, such as the retail sales industry.

### SUMMARY

According to an embodiment of the present invention, a method includes selectively choosing data relating to one or more types of transactions to form selectively chosen data, and enriching the selectively chosen data with other data to form enriched data. The method also includes graph modeling the enriched data to form modeled graphs, discovering any patterns of metrics from within the modeled graphs, wherein the metrics relate to a relationship network between two or more people, and processing reports of the discovered patterns.

According to another embodiment of the present invention, a system includes a processor in communication with one or more types of memory, the processor configured to selectively choose data relating to one or more types of transactions to form selectively chosen data, and enrich the selectively chosen data with other data to form enriched data. The processor is also configured to graph model the enriched data to form modeled graphs, discover any patterns of metrics from within the modeled graphs, wherein the metrics relate to a relationship network between two or more people, and process reports of the discovered patterns.

According to yet another embodiment of the present invention, a computer program product includes a non-transitory storage medium readable by a processing circuit and storing instructions for execution by the processing circuit for performing a method that includes selectively choosing data relating to one or more types of transactions to form selectively chosen data, and enriching the selectively chosen data with other data to form enriched data. The method also includes graph modeling the enriched data to form modeled graphs, discovering any patterns of metrics from within the modeled graphs, wherein the metrics relate to a relationship network between two or more people, and processing reports of the discovered patterns.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to an embodiment of the present invention;

FIG. 2 depicts abstraction model layers according to an embodiment of the present invention;

FIG. 3 is a block diagram illustrating one example of a processing system for practice of the teachings herein;

FIG. 4 is a diagram of an architecture of a network comprised of various computer elements in accordance with an embodiment of the present invention;

FIG. 5 is a flow diagram of a method for creating and maintaining a patient and doctor relationship network in accordance with an embodiment of the present invention; and

FIG. 6 is a screen shot of various data points presented in various forms, including a graph visualization form, to a user in accordance with an embodiment of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

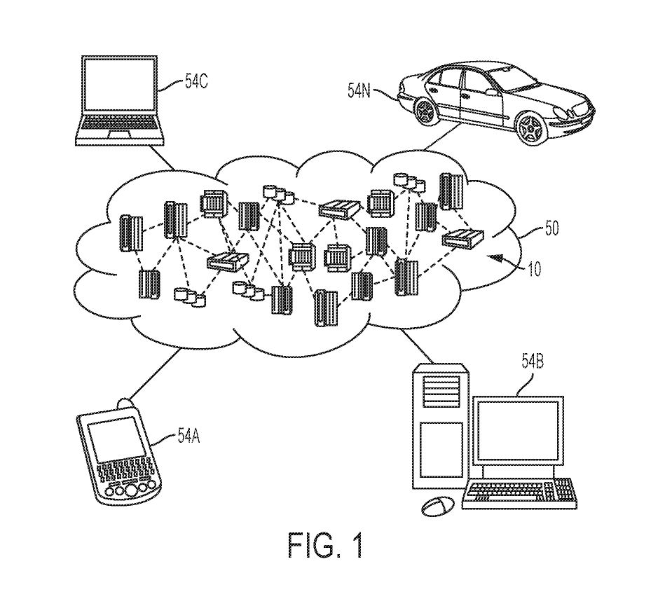

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

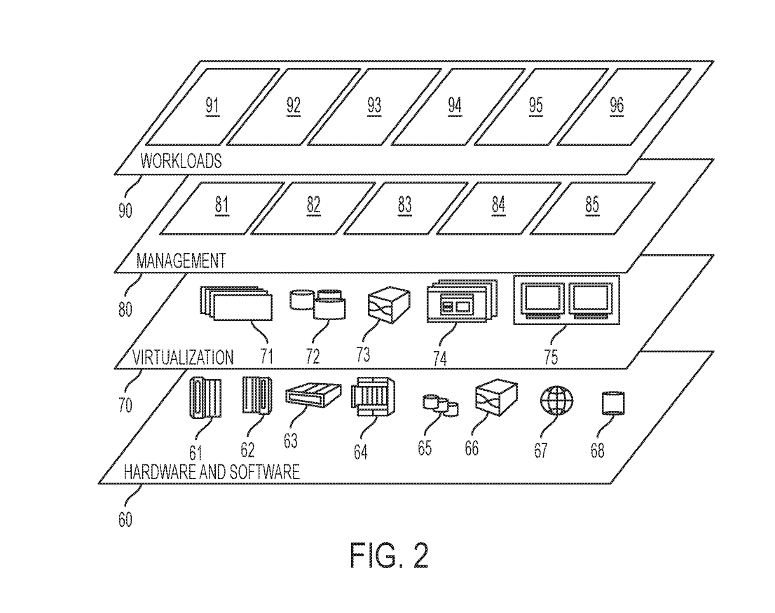

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a method 96 for utilizing transactional type health care data within various types of relationships or social networks (e.g., doctor-patient) in the health care industry and for determining various patterns of data therefrom to support improved decision making based on the determined data patterns.

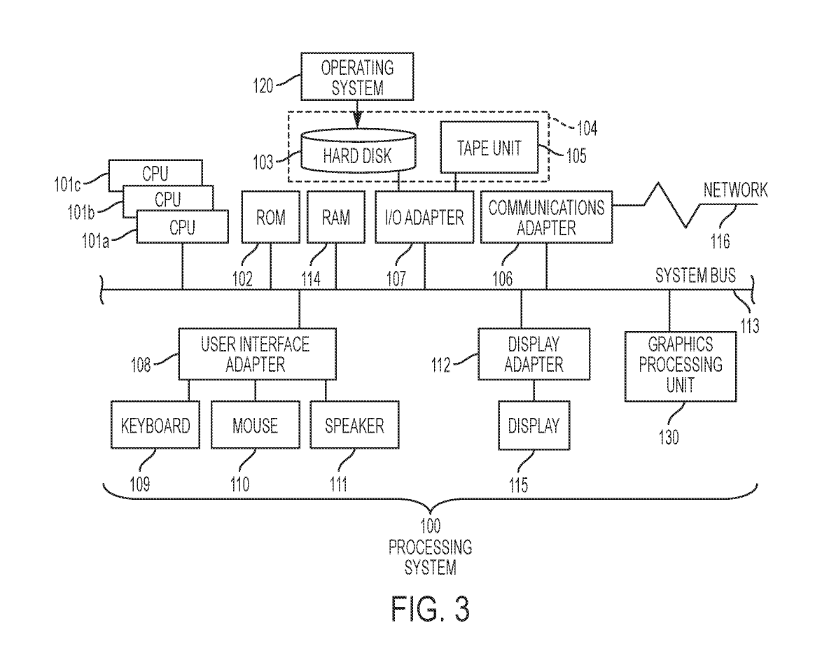

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

In accordance with exemplary embodiments of the present invention, methods, systems, and computer program products are disclosed for utilizing transactional type health care data within various types of relationships or social networks (e.g., doctor-patient) in the health care industry, and for determining various patterns of data therefrom to support improved decision making based on the determined data patterns.

Embodiments of the present invention support health care organizations in the decision making process by involving the determination of patterns of data within various relationships, including patient-doctor behaviors, detection of issues such as fraud, abuse and overuse, data outlier detection, consultation and claim prediction, and other relationship parameters among doctors and patients. Through the various embodiments of the present invention, health care organizations can better identify doctors that bring relatively greater value to those organizations based on a plurality of various patterns or metrics.

In various embodiments, transforming the transactional type data from health care organizations into a relationship network to analyze doctor-doctor, doctor-patient, or patient-patient relationships, allows one to better determine multiple complex patterns or metrics that may assist in identifying fraud, outliers, consultation behavior, mutual referrals, patient-doctor fidelity, patient retention, best practices versus bad practices, and other related patterns. This transactional data can also be enriched with external data (e.g., from a social network, social media, a medical database, etc.), or even other transactional data. Embodiments of the present invention disclose a method, system and a computer program product that use transactional health care data to support decision making based on patterns or metrics found in a relatively complex relationship network. Embodiments may model doctor-doctor, doctor-patient, and patient-patient relationship networks, supporting descriptive and predictive analytics regarding matters such as mutual referrals, centrality, and consultation return.

Embodiments may be directed to professionals (e.g., health care insurance company employees) in positions involving the analysis of doctors' and patients' behaviors regarding claims, consultations, exams, prescriptions, etc. Embodiments may not be intended for use by patients or doctors.

Embodiments may consider cost and fraud as exemplary attributes in the relationship networks. However, a number of other attributes may be considered and also in different models of a relationship network, e.g., involving doctor-patient and doctor-doctor relationship networks. Also considered may be descriptive and predictive analytics. Further, the relationship network may be modeled based on various common health care industry transactions, e.g., claims, consultations, etc.

Embodiments may consider prescriptions as one of the data sources, but embodiments may also consider a number of other types of common health care industry transactions as data sources, which may all be merged in doctor-doctor, doctor-patient, and/or patient-patient complex relationship networks.

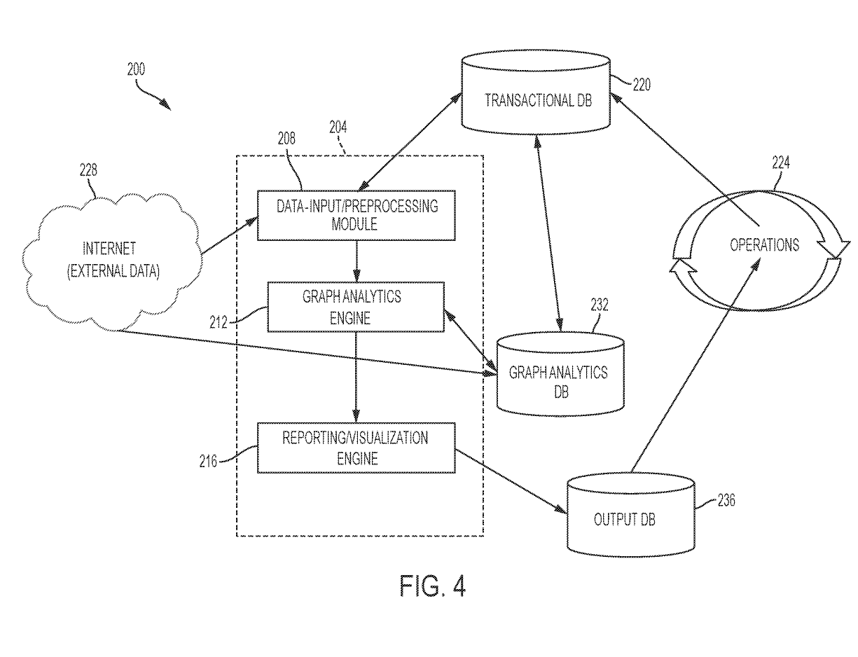

With reference now to FIG. 4, there illustrated is a diagram of an architecture of a network 200 comprised of various computer elements (e.g., processor, data storage) that may implement an embodiment of the present invention. In various embodiments, the network and the computer elements may reside in the cloud, such as the cloud computing environment 50 described hereinabove and illustrated in FIGS. 1 and 2. In other embodiments, the computer elements may reside on a computer system or processing system, such as the processing system 100 described hereinabove and illustrated in FIG. 3 which may be configured to implement one or more networks that encompass the various computing components such as one or more processors, storage or memory, a user interface, and a video display device.

The network of FIG. 4 may comprise one or more processors 204 that each may comprise or include functionality in the form of a data input and pre-processing module 208, a graph analytics engine 212, and a reporting/visualization engine 216. The data input and pre-processing module 208 may connect with a transactional database 220 which may store the transactional type health care data discussed hereinabove (for example, doctor-patient consultations (e.g., diagnostic and treatment advice given by doctors to patients), patient claims filed and processed by health insurers, prescriptions written by doctors and filled by pharmacies, exams (e.g., X-Rays, Mills) provided by doctors and third parties, and other similar type events that routinely occur in the health care industry. This data may be provided by the various routine operations 224 performed in the health care industry.

Also input to the data input and pre-processing module 208 is external data from, e.g., the internet 228. This external data 228 (e.g., from a social network, social media, a medical database, etc.), or even other transactional data may augment or enrich the transactional data from the database 220.

Following the data input and pre-processing module 208 is the graph analytics engine 212 that is configured to develop the various types of relationship networks such as, for example, doctor-patient, doctor-doctor, and patient-patient. These networks can be thought of as more like graphs than a network such as the internet. The node identifier may be the name or other identifying characteristic of the doctor or patient. For the doctor-patient network, the doctors and patients are considered as nodes in the network, and a link may be established whenever a patient visits a doctor, so that there is a medical claim relating the patent with the doctor. For the doctor-doctor network, the physicians are the nodes, and the physicians may be linked if they have patients in common. For the patient-patient network, the patients are the nodes, and the patients may be linked if they share doctors. There are more possible network definitions, capturing different aspects of the relationships among the different stakeholders (for instance, using health care providers). The various links between the various nodes may have a time stamp associated with them.

Associated with the graph analytics engine 212 is a graph analytics database 232 that may store data utilized by the graph analytics engine 212 and output therefrom. The graph analytics database 232 may also receive data from the external data source such as the internet 228.

Following the graph analytics database 232 is the reporting/visualization engine 216. This module 216 is configured to provide the visual reports to the user, such as, for example, histograms, graphs, charts, etc.). The reporting/visualization engine 216 may connect with an output database 236 that stores the various visual reports.

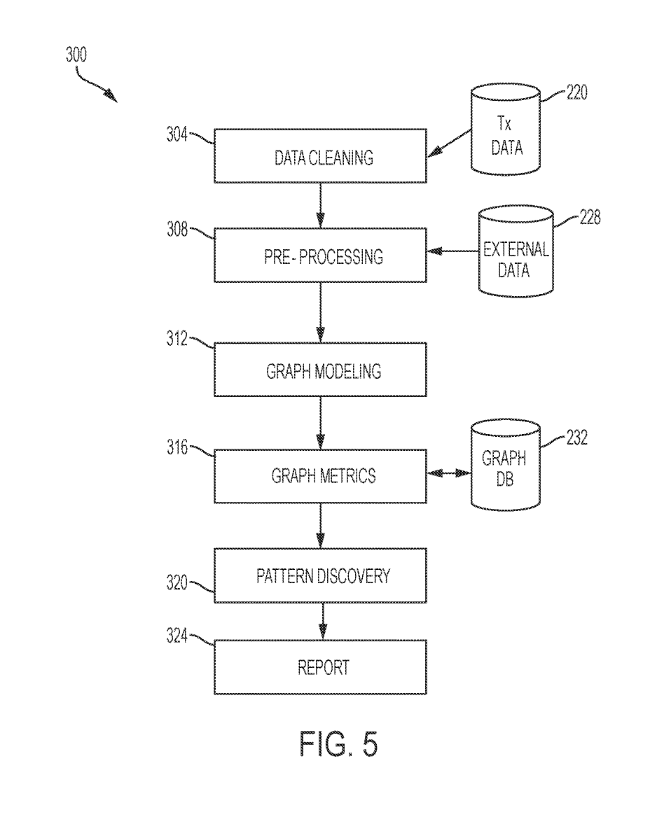

FIG. 5 is a flow diagram of a method 300 for creating and maintaining a doctor-patient relationship network in accordance with an embodiment of the present invention. As discussed hereinabove, the doctor-patient relationship network is merely one example of a type of relationship network that is utilized in health care embodiments of the present invention. Other possible relationship networks include doctor-doctor, and patient-patient.

In a step 304, data cleaning takes place in which the transactional health care data is cleaned (i.e., selectively chosen) prior to the creation of the doctor-patient relationship network. The transactional health care data may be stored in the transactional database 220 shown in FIG. 4. Next, in a step 308, pre-processing take place in which the transactional data may be enriched with external data for example, from the internet, a social network, social media, a medical database, or even other transactional data. The external data may be stored on the database 228 shown in FIG. 4.

In a step 312, a graph modeling function takes place. Various sub-functions may be carried out in this step, including enriching the doctor-patient relationship network with external data such as that discussed above with respect to step 308, but also including data from other sources such as Twitter, Facebook, medical databases, digital libraries, etc. Other sub-functions include a claims classifier, a temporal network analysis, and a calculation of various indicators or metrics (i.e., for nodes and edges within the network)—graph metrics in a step 316. These metrics may include, for example and without limitation, mutual referrals, doctor-patient fidelity, centrality, and return consultations with the same doctor by a patient. Still other metrics may include data outlier detection (e.g., fraud, abuse or unnecessary overuse). This graph metrics step 316 may utilize the graph analytics database 232 from FIG. 4.

Next, in a step 320 pattern discovery may take place. This may involve the combining of indicators and metrics with data from the transactional database 220 (FIG. 4). Finally, a step 324 may be executed in which various reports of the discovered patterns are processed. These reports may include, for example and without limitation, histograms, graphs, charts, etc.

In other embodiments of the present invention, there may be a user consumption of descriptive visual analytics reports. This may include a registered user authenticating into the system, and the user requests one of the reports available. These reports may include, for example and without limitation, patient retention by doctors, mutual referral/indication between doctors, doctors with high centrality measures in the network, histograms of denied and approved claims for groups of doctors based on geolocation, doctor-doctor relationship network, doctor-patient relationship network, patient-patient relationship network, consultations return time metrics, and patterns relating to patient-doctor consultations and claims.

In other embodiments of the present invention, there may be a user consumption of predictive analytics report. This may include a registered user authenticating into the system, and the user requests or selects on of the prediction reports available. These reports may include, for example and without limitation, fraud detection, predicting new connections in a doctor-doctor network, predicting new connections in a patient-doctor network, predicting new connections in a patient-patient network, and predicting trends regarding any metrics or indicators presented. Then, the user defines the time window to consider in the prediction. The system runs the selected prediction, and the system returns the predicted report to the user.

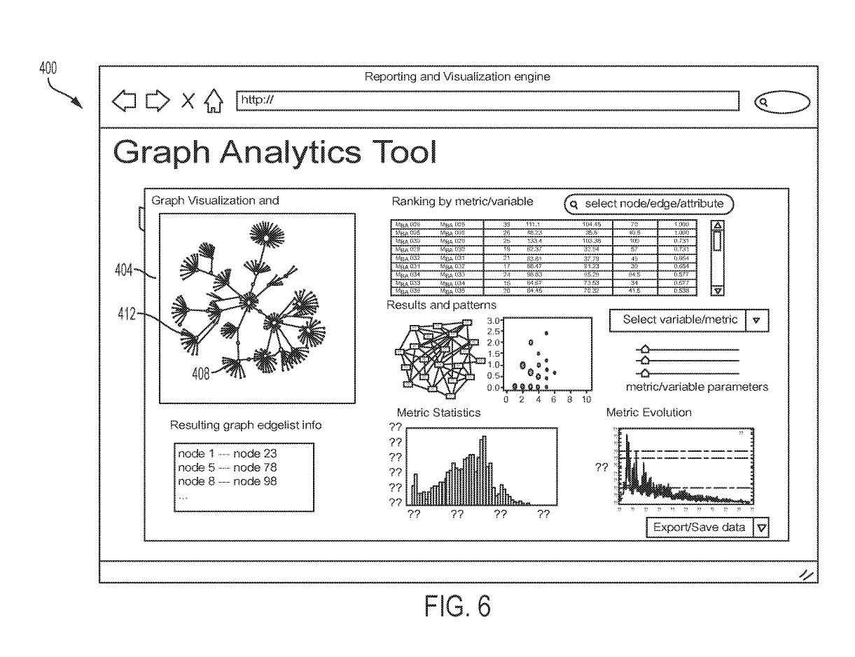

FIG. 6 is a screen shot 400 on a display screen of a computer of various data points presented in various forms, including a graph visualization form, to a user in accordance with an embodiment of the present invention. For example, a visual graph 404 that depicts a doctor-patient relationship network may show a doctor as a central point or node 408 and with a multiple of patients 412 shown branching off of the doctor node 408.

Two exemplary business cases are now described with respect to embodiments of the present invention. The first is “mutual referral” in which a health care insurance company may want to analyze a doctor referral network to identify, for example, overuse/abuse patterns or pairs (or small groups) of doctors that usually work together in solving cases. The referral metric can be used to identify the most common pairs of doctors. Analysts can perform a “deep dive” for each of the mutual referral cases in order to validate the identified relationship and try to differentiate between excellency and overuse/abuse of health insurance services

Another exemplary business case is patient retention. Here, a health care insurance company may want to identify, via complex network analysis, doctors that have a relatively high retention rate of patients, as a proxy for “loyalty” between patient and doctor. This way it is possible to identify or infer the doctors that apply protocols that strengthen the link between a patient and a doctor. Moreover, it may suggest doctors are the best for the health care company to partner with.

As described hereinabove and illustrated herein, in accordance with exemplary embodiments of the present invention, methods, systems, and computer program products are disclosed for utilizing transactional type health care data within various types of relationships or social networks (e.g., doctor-patient) in the health care industry and for determining various patterns of data therefrom to support improved decision making based on the determined data patterns. However, other embodiments of the present invention may relate not to the health care industry but to other types of service industries, such as, for example, the retail sales industry. It should be apparent to one of ordinary skill in the art in light of the teachings here how to adapt the heath care embodiments to retail sales, or other embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
selectively choosing data relating to one or more types of transactions to form selectively chosen data;
enriching the selectively chosen data with other data to form enriched data;
graph modeling the enriched data to form modeled graphs;
discovering any patterns of metrics from within the modeled graphs, wherein the metrics relate to a relationship network between two or more people; and
processing reports of the discovered patterns.

2. The method of claim 1 wherein the data relating to the one or more types of transactions is stored in a transactional database.

3. The method of claim 1 wherein enriching the selectively chosen data with other data to form enriched data comprises enriching the selectively chosen data with data from external data from the group comprising data from the internet, data from a social network, data from a social medium, and data from a database.

4. The method of claim 1 wherein the one or more types of transactions relate to a health care field.

5. The method of claim 4 wherein the metrics relate to a relationship network between two or more people that include a doctor-patient relationship network, a doctor-doctor relationship network, and a patient-patient relationship network.

6. The method of claim 4 wherein the metrics include data outliers from the group comprising fraud, abuse and unnecessary overuse.

7. The method of claim 1 further comprising providing for a user consumption of descriptive visual analytics reports, and a user consumption of predictive analytics reports.

8. A system comprising:
a processor in communication with one or more types of memory, the processor configured to:
selectively choose data relating to one or more types of transactions to form selectively chosen data;
enrich the selectively chosen data with other data to form enriched data;
graph model the enriched data to form modeled graphs;
discover any patterns of metrics from within the modeled graphs, wherein the metrics relate to a relationship network between two or more people; and
process reports of the discovered patterns.

9. The system of claim 8 wherein the data relating to the one or more types of transactions is stored in a transactional database.

10. The system of claim 8 wherein the processor being configured to enrich the selectively chosen data with other data to form enriched data comprises the processor being further configured to enrich the selectively chosen data with data from external data from the group comprising data from the internet, data from a social network, data from a social medium, and data from a database.

11. The system of claim 8 wherein the one or more types of transactions relate to a health care field.

12. The system of claim 11 wherein the metrics relate to a relationship network between two or more people that include a doctor-patient relationship network, a doctor-doctor relationship network, and a patient-patient relationship network.

13. The system of claim 11 wherein the metrics include data outliers from the group comprising fraud, abuse and unnecessary overuse.

14. The system of claim 8 further comprising the processor being configured to provide for a user consumption of descriptive visual analytics reports, and a user consumption of predictive analytics reports.

15. A computer program product comprising:
a non-transitory storage medium readable by a processing circuit and storing instructions for execution by the processing circuit for performing a method comprising:
selectively choosing data relating to one or more types of transactions to form selectively chosen data;
enriching the selectively chosen data with other data to form enriched data;
graph modeling the enriched data to form modeled graphs;
discovering any patterns of metrics from within the modeled graphs, wherein the metrics relate to a relationship network between two or more people; and
processing reports of the discovered patterns.

16. The computer program product of claim 15 wherein enriching the selectively chosen data with other data to form enriched data comprises enriching the selectively chosen data with data from external data from the group comprising data from the internet, data from a social network, data from a social medium, and data from a database.

17. The computer program product of claim 15 wherein the one or more types of transactions relate to a health care field.

18. The computer program product of claim 17 wherein the metrics relate to a relationship network between two or more people that include a doctor-patient relationship network, a doctor-doctor relationship network, and a patient-patient relationship network.

19. The computer program product of claim 17 wherein the metrics include data outliers from the group comprising fraud, abuse and unnecessary overuse.

20. The computer program product of claim 15 further comprising providing for a user consumption of descriptive visual analytics reports, and a user consumption of predictive analytics reports.
